(19) United States
(12) Patent Application Publication
(10) Pub. No.: US 2025/0016152 A1
(43) Pub. Date: Jan. 9, 2025

(54) REMOTE CONFERENCE SECURITY CONTROL

(71) Applicant: INTERNATIONAL BUSINESS MACHINES CORPORATION, ARMONK, NY (US)

(72) Inventors: Timothy Andrew Moran, Southampton (GB); Caroline Sarah Courtenay McNamara, Hants (GB); Abigail Rose Bettle-Shaffer, Andover (GB); NATASHA Katherine MCKENZIE-KELLY, Salisbury (GB); Robert Paterson, High Wycombe (GB); MELITA SAVILLE, Winchester (GB); BETHANY FAY SIMPSON, Maidstone (GB)

(21) Appl. No.: 18/347,629

(22) Filed: Jul. 6, 2023

(51) Int. Cl. H04L 9/40

(52) U.S. Cl. CPC H04L 63/0861; H04L 63/1425

(57) ABSTRACT

A method, computer program product, and computer system for remote conference security control. The method includes monitoring an audio and/or a video input for participants at one or more remote locations of a remote conference meeting irrespective of sharing of the audio and/or the video input at the time of monitoring. The method compares an extraction of a detected voice and/or face input with a registered profile of the participant to detect non-registered participants. When detecting a non-registered participant, the method provides an output action to at least some of the participants of the remote conference meeting to the non-registered participant.

### BACKGROUND

The present disclosure relates to remote conferencing systems, and more specifically, to security control during remote conferences.

Historically, confidential business issues have been discussed ‘behind closed doors’, in meeting rooms with an expected and known set of participants. The arrival of an unexpected attendee would be noticed by other participants and would provoke a response. The response may be anything from changing the topic of discussion, to asking that person to leave, to alerting security if the person is unauthorized on the premises.

In traditional teleconferences in which such meetings were virtual, some or all of the participants were likely to be in a controlled environment such as a secure office. Access to the contents of the meeting would also be protected by a chairperson acting as gatekeeper or by use of a passcode.

These meetings are now increasingly held through online conferencing software in less predictable or less controlled locations, such as home offices. This risks the information to ‘leak’ into the environments of each participant. For example, a family member may unexpectedly walk into a home working environment during a conference call. In another example, a stranger might appear next to someone working in a public space such as a library, airport, or drop-in workspaces.

The arrival of unexpected attendees in any remote conference environments will go unnoticed by the majority of participants on the conference call, leading to an increased likelihood of confidential information being overheard without the authorization or knowledge of the participants who are sharing that information. The information that is shared might be audible (for example, a spoken discussion of a corporate strategy). The information that is shared might be visual using screen sharing functions (for example, slides, screens, or videos showing confidential financial information).

### SUMMARY

According to an embodiment of the present disclosure there is provided a computer-implemented method for remote conference security control. The method includes monitoring an audio and/or video input for participants at one or more remote locations of a remote conference meeting irrespective of sharing of the audio and/or video input at the time of monitoring. The method further includes comparing an extraction of a detected voice and/or face input with registered profiles of participants to detect non-registered participants. The method further includes, when detecting a non-registered participant, providing an output action to at least some of the participants of the remote conference meeting.

According to another embodiment of the present disclosure there is provided a system for remote conference security control. The system includes a processor and a memory configured to provide computer program instructions to the processor to execute the function of the components. The system further includes a monitoring component for monitoring an audio and/or a video input for participants at one or more remote locations of a remote conference meeting configured to monitor irrespective of sharing of the audio and/or video input at the time of monitoring. The system further includes a comparing component for comparing an extraction of a detected voice and/or face input with registered profiles of participants to detect non-registered participants. The system further includes an output component for, when detecting a non-registered participant, providing an output action to at least some of the participants of the remote conference meeting.

According to another embodiment of the present disclosure there is provided a computer program product for remote conference security control. The computer program product includes a computer readable storage medium having program instructions embodied therewith, the program instructions executable by a processor to cause the processor to monitor an audio and/or video input for participants at one or more remote locations of a remote conference meeting irrespective of sharing of the audio and/or video input at the time of monitoring. The processor is further caused to compare an extraction of a detected voice and/or face input with registered profiles of participants to detect non-registered participants. The processor is further caused to, when detecting a non-registered participant, provide an output action to at least some of the participants of the remote conference meeting.

The computer readable storage medium may be a non-transitory computer readable storage medium and the computer readable program code may be executable by a processing circuit.

### BRIEF DESCRIPTION OF THE DRAWINGS

Embodiments of the present disclosure will now be described, by way of example only, with reference to the accompanying drawings:

FIG. 1 is a flow diagram of a first example embodiment of a method in accordance with embodiments of the present disclosure.

FIG. 2 is a flow diagram of a second example embodiment of a method in accordance with embodiments of the present disclosure.

FIG. 3 is a block diagram of an example conferencing environment in which the present disclosure may be implemented.

FIG. 4A and FIG. 4B are block diagrams of example embodiments of computer program product modules in accordance with embodiments of the present disclosure.

FIG. 5 is a block diagram of an example embodiment of a computing environment for the execution of at least some of the computer code involved in performing the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided for remote conference security control. Remote conferences use computer or telecommunications systems to link multiple participants from remote locations in an online conference or a teleconference. One or more participants may be at each location.

Security and the protection of confidential information that may be disclosed and discussed at such remote conferences is important in business and other sectors. Most remote conferencing systems have an ability to hide a video picture and/or mute the sound of a participant or multiple participants at a given location. This means that it is possible for an unauthorized participant to be present.

The described method and system monitor audio and/or video input to detect and identify participants at a remote location of a remote conference meeting. The monitoring is carried out irrespective of sharing of the audio and/or video input at the time of monitoring. An extraction of a captured voice and/or face input is compared with a registered profile of the participant(s) to determine if a non-registered voice or face is detected. When a non-registered participant is detected, an output may alert all participants of the remote conference meeting to the non-registered participant. The sharing of information may also be automatically modified.

Remote conference security control is an improvement in the technical field of computer security generally and more particularly in the technical field of controlling access to conference content.

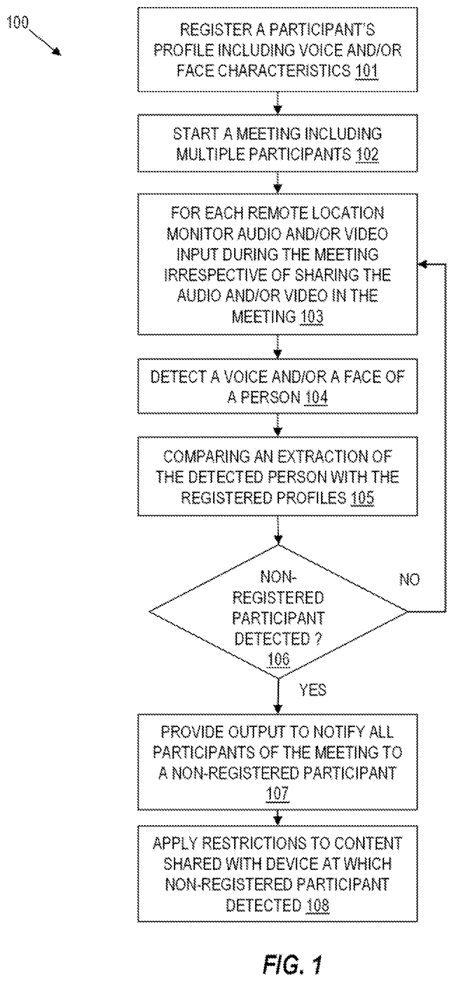

Referring to FIG. 1, a flow diagram 100 shows an example embodiment of the described method for remote conference security control.

The method registers 101 participants with a participant profile including voice and/or face characteristics. Participants may have a long term registration or may register before a meeting. The registration may take place locally, at a computing device at a location, or centrally at a remote conferencing server.

A remote conference meeting may be started 102 including multiple participants across remote locations. Each remote location may have one or more participants present. For example, a remote location may be a user's home office with a single computing device for a single user or two users. In another example, a remote location may be a conference room with a conference computing system suitable for use by multiple users, including multiple or rotating camera(s), multiple or directional microphones, and a shared display screen.

For each remote location of the conference meeting, the method may monitor 103 audio and/or video irrespective of sharing of the audio and/or video input in the conference at the time of monitoring. The monitoring may be continuous or at intervals during the meeting. The monitoring of the audio is irrespective of muting of a participant on the conference call. The monitoring of the video is irrespective of whether the video is streamed to the other participants and the monitoring may also be irrespective of any filters applied to the foreground or background of the video content shared in the conference.

In the case of a single participant at a computing device, the method may monitor audio and/or video by use of the microphone and/or camera of the computing device. In the case of multiple participants, the conference computer system may continuously monitor the environment, for example, by scanning a camera around a room and by capturing audio in the room. For example, in a conference computer system using a rotating camera that focuses on a participant who is speaking, a background monitoring camera may scan the other areas of the room.

The method may detect 104 a voice and/or a face of a person at location of the conference meeting and may capture characteristics extracted from the voice and/or face.

The method may compare 105 the detected voice and/or face characteristics as extracted from the monitored audio and/or video with a registered profile or set of profiles of the participant(s) of the remote location. This may use known voice and face detection methods that analyze audio to extract voice signatures or video to extract face features. More than one voice or face may be detected in the audio and video respectively. The described method checks for detection of unexpected persons during a conference call by scanning for faces and voice recognition patterns that are not recognized.

It may be determined 106 if a non-registered participant is detected. If no non-registered participant is detected the method may continue to monitor 103 audio and/or video inputs.

When detecting a non-registered participant, the method may provide an output action to at least some of the participants of the remote conferencing meeting. The output action may be a notification, such as an alert, and/or may be a modification of sharing of the conference meeting to or from the location at which the non-registered participant is detected.

The output action may provide 107 a notification, such as an alert, to at least some of the participants of the remote conference meeting of the arrival of a non-registered participant. For example, this may notify only an administrator of the meeting, just the participants at other locations other than where the non-registered participant is detected, or all participants.

This proactively notifies other participants that an unauthorized attendee has been detected. This makes other participants aware that their conversations may be overheard by a non-authorized person. Participants will then know not to discuss confidential information, and will be made aware that confidential information already discussed may have been seen or heard by that user.

Just as an attendee in a physical environment would be aware of an unexpected attendee walking through the door of the meeting room, the method alerts attendees when an unexpected attendee is detected in any of the remote locations that have access to the meeting.

Alerting other users that an unauthorized user has been detected is valuable because it allows them to modify their behavior from the point of detection, i.e. stop sharing or discussing confidential material until the unauthorized participant has left. This may be preferable to removing an authorized participant (in the same environment as the unauthorized participant) from the conference call. For example, the non-registered person may be a legitimate guest but may have different security level access to information.

Alerting users also allows them to consider the security impact of any information that was shared immediately prior to the detection of the unauthorized participant. This information may have been received by the unauthorized participant before they were detected.

The output action may modify 108 the sharing of content in the conference meeting. This may include restricting the content shared with the computing device at which the non-registered participant is detected. This may include restricting the content shared from the computing device at which the non-registered participant is detected. These restrictions may be a temporary suspension during which time the non-registered person is registered or asked to leave.

The method may automatically modify the connection of the device at which the non-registered participant is detected in response to an unexpected person being detected in the environment of a participant. This will proactively prevent unintended information leaks.

The method may also stop sharing the audio and/or video content from the computing device at which the non-authorized participant is detected with the conference call. For example, if a child or family member has unexpectedly appeared on the call, this would automatically protect the participant's right to privacy in their home environment.

The modification 108 to sharing of the content may take place without an alert being provided to all participants at the meeting. For example, a registered user may be in the conference meeting from a location and a person enters the environment of the location, the input and output for the meeting may be suspended until the person leaves. This may be carried out without notifying the other participants.

The appearance and voice profiles of participants are known by registering them as user profiles. When any of these people are participants in a conference, their environment can be scanned to detect other faces and/or voice patterns that are not recognized. In the event that a non-recognized individual is detected, the conferencing system may modify its behavior, for example by stopping sharing audio and video with this participant and/or by alerting other participants that their conversation may be overheard.

In one embodiment, the method may focus on voice inputs and may only monitor audio inputs. This has the advantage of simplifying the monitoring to a use of a microphone which may be appropriate in a shared room scenario where a camera may not detect all faces. This also enables the method to be used when a voice only conference meeting is being held.

In another embodiment, the method may focus on face inputs and may only monitor video inputs. This has the advantage of detecting the presence of a person even when they do not speak. In a further embodiment, a combination of both voice and face monitoring is used with detection of either a voice or face being compared to registered profiles.

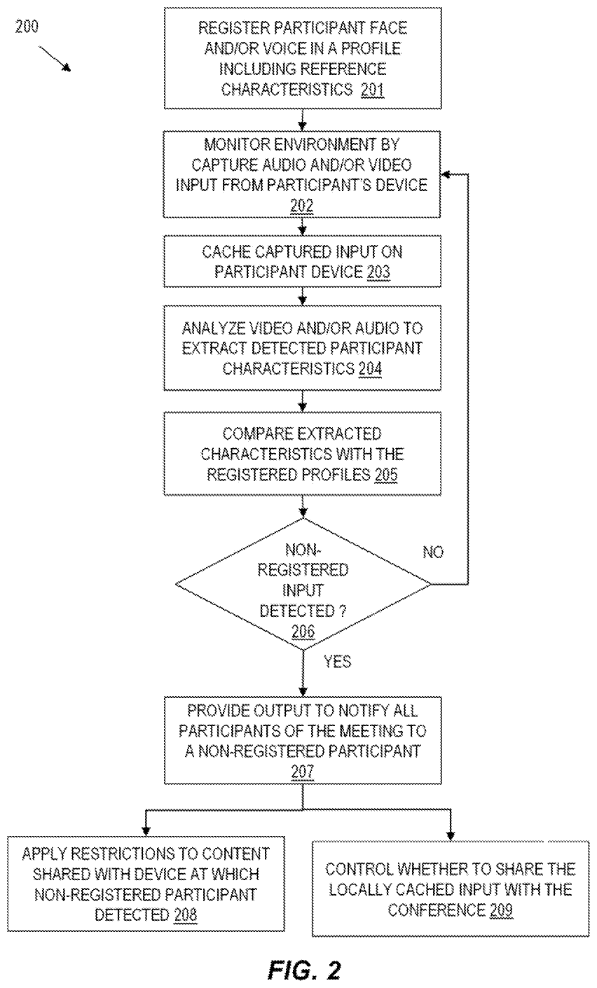

Referring to FIG. 2, a flow diagram 200 shows a further example embodiment of the described method for remote conference security control as implemented on a computing device at a participant location. A computing device may use a local client conferencing software including functionality for the described security.

The method may register 201 a participant's voice and/or face in a user profile including reference characteristics of the voice and/or face. The registered profile may be stored locally at the computing device.

During a meeting, the method may monitor 202 the user environment of the location by capturing audio and/or video input from the participant's computing device using the microphone and/or camera. This may be captured regardless of whether or not the user is muted on the conference or if their video stream is not being broadcast to the conference. The capture may be continuous or at discrete intervals. The captured input may be cached 203 at the computing device, for example, in the local client conferencing software.

The method may analyze 204 the cached audio and/or video to extract characteristics of captured person(s). The extracted characteristics may be compared 205 with the registered profile(s) on the computing device.

The video may be analyzed to extract one or more faces. The extracted faces may be compared to faces of authorized participants. These steps may each be done in local client software or on a remote system.

The audio may be analyzed to extract one or more voice signatures. The extracted voice signatures may be compared to voice signatures of authorized participants. These steps may each be done in local client software or on a remote system.

The analysis may recognize a registered participant who is a regular user of the computing device and may aim to detect any voice and/or face input that is not the regular participant. In this way, the regular participant's voice and/or face input may be disregarded and only detected different voice and/or face inputs captured.

The user's voice and face may be correlated with the computer (for example, with the IP address) that they are using. Over time, a pattern may be established of regular use from that computing location. Association with a device may enhance “intelligence” behind pattern matching. The method essentially checks “do I know and authorize this face/voice?”; therefore, association of a user with a device does not eliminate those checks but it may enhance the intelligence.

It may be determined 206 if a non-registered person is detected. If no non-registered person is detected, the method may continue to monitor the environment. If a non-registered user is detected, the method may provide 207 an output to notify some or all participants of the meeting at other remote locations to the presence of a non-registered participant.

The method may apply 208 restrictions to the content shared with or from the computing device at which the non-registered participant was detected. The method may also control 209 whether to share the locally cached input with the conference system.

In another embodiment, a more centralized system may be implemented in which at least some of the method is carried out at a remote conferencing server where all detected voice and/or faces are compared with a central registry of registered participants. This will allow a person who is registered centrally to be authorized if they are detected at a different computing device at a different location.

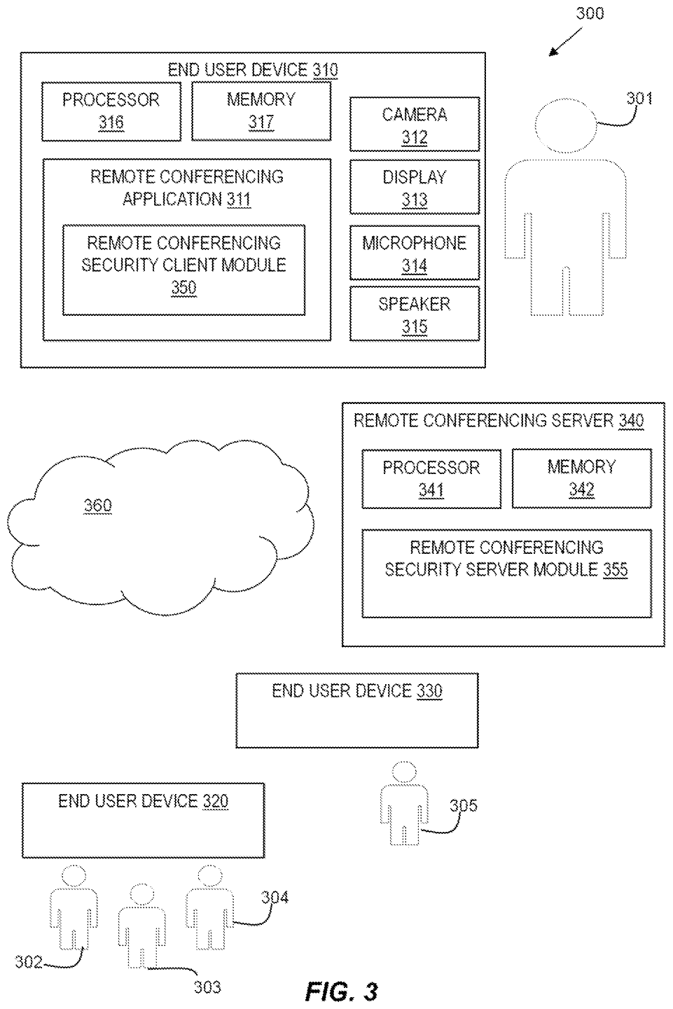

Referring to FIG. 3, a block diagram shows an example conferencing system 300. The system 300 shows end user devices 310, 320, and 330 that may be a computing device at a location of one or more participants 301, 302, 303, 304, and/or 305. For example, a single participant 301, 305 may use an end user device 310, 320, respectively, or multiple participants 302, 303, and 304 may use an end user device 320 collectively such as a conference room system.

The end user devices 310, 320, and 330 may include at least one processor 316, a hardware module, or a circuit for executing the functions of the described components which may be software units executing on the at least one processor. Memory 317 may be configured to provide computer instructions to the at least one processor 316 to carry out the functionality of components such as a remote conferencing application 311 and the remote conferencing security client module 350.

An end user device 310 may include a camera 312 for recording a video in the vicinity of the end user device 310 and a microphone 314 for recording an audio in the vicinity of the end user device 310. An end user device 310 may include a display 313 for display of content on the end user device 310 and a speaker 315 for broadcasting audio at the end user device 310.

Each end user device 310, 320, and 330 may include a remote conferencing application 311 that may be, for example, a downloaded application or a web-based application on the device. In the described system, a remote conferencing security client module 350 may be provided as part of or associated with the remote conferencing application 311.

A remote conferencing server 340 may provide the service of the remote conferencing applications 311 to the end user devices 310, 320, and 330 and may include a corresponding remote conferencing security server module 355. The remote conferencing server 340 and the end user devices 310, 320, and 330 may be provided in a networked 360 environment to enable the remote conferencing functionality.

The remote conferencing server 340 may include at least one processor 341, a hardware module, or a circuit for executing the functions of the described components which may be software units executing on the at least one processor. Multiple processors running parallel processing threads may be provided enabling parallel processing of some or all of the functions of the components. Memory 342 may be configured to provide computer instructions to the at least one processor 341 to carry out the functionality of components such as the remote conferencing security server module 355.

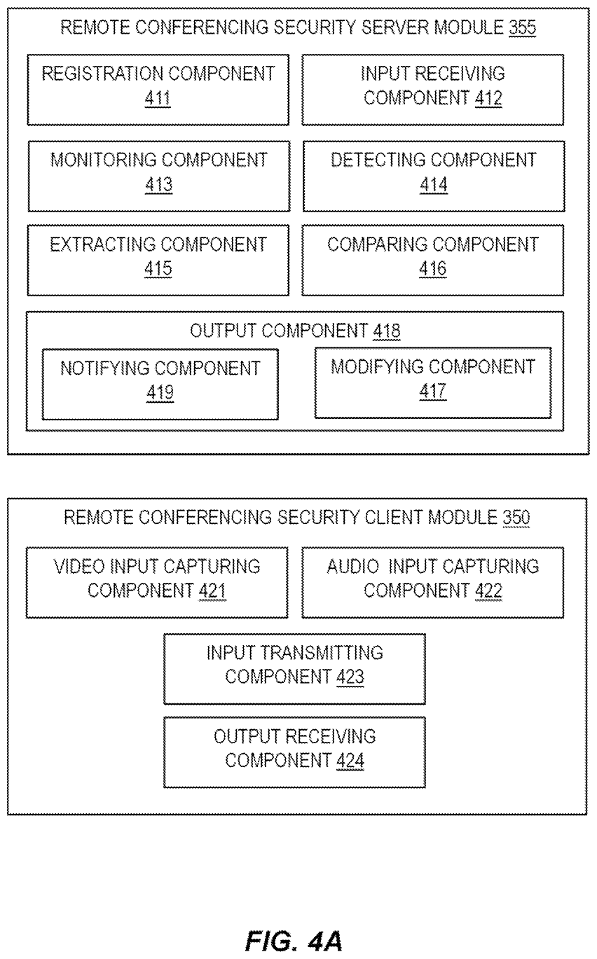

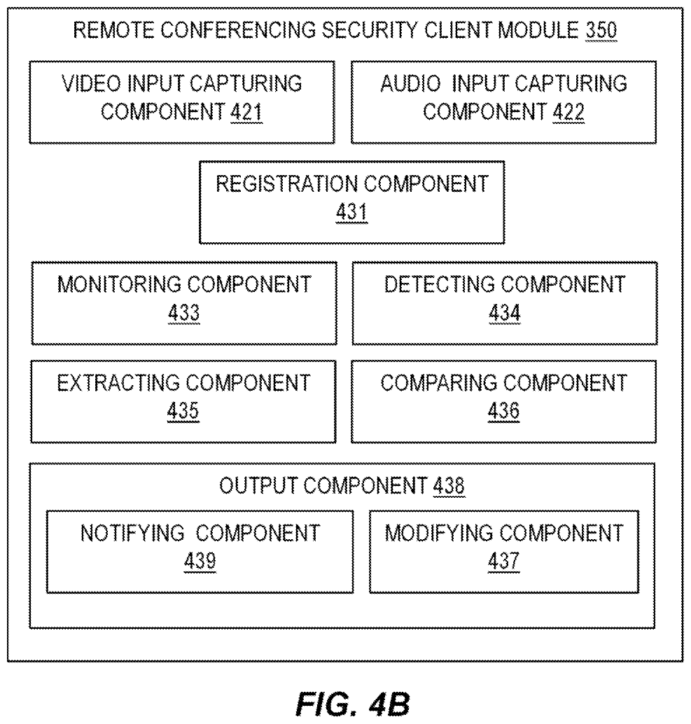

FIG. 4A and FIG. 4B show block diagrams of two embodiment of the remote conferencing security server module 355 and the remote conferencing security client module 350. In the first embodiment of FIG. 4A, most of the processing is carried out at the remote conferencing security server module 355 with the remote conferencing security client module 350 forwarding the input for monitoring. In the second embodiment of FIG. 4B, most of the processing is carried out at the remote conferencing security client module 350.

As seen in the two example embodiments, some of the components may be implemented either at the server module 355 or the client module 350 depending on an implementation.

FIG. 4A shows the remote conferencing security server module 355 that is in network communication with multiple end user devices that run remote conferencing security client modules 350.

The remote conferencing security server module 355 includes a registration component 411 for registering participants by extracting voice and/or face characteristics for a participant profile. The registration component 411 may register participants across all user end devices at remote locations to provide a central store of participant profiles.

The remote conferencing security server module 355 includes an input receiving component 412 for receiving audio and/or video input from the end user devices at the remote locations.

Each of the remote conferencing security client modules 350 may include a video input capturing component 421, an audio input capturing component 422, and an input transmitting component 423 for transmitting the input to the server module 355. In some embodiments, voice and face characteristics may be extracted at the client module 350 and only the characteristics are transmitted to the server module 355. The video input capturing component 421 and the audio input capturing component 422 may be configured to capture the audio and video input at remote locations irrespective of sharing of the audio and video input by participants with the meeting at the time of monitoring. In some embodiments, the video input capturing component 421 and/or the audio input capturing component 422 may be independent of the captured input to the conference meeting.

The remote conferencing security server module 355 includes a monitoring component 413 for monitoring an audio and/or a video input for participants at remote locations of a remote conference meeting.

The remote conferencing security server module 355 may include a detecting component 414 for detecting a voice and/or face input in the monitored audio and/or video input and an extracting component 415 for extracting characteristics of the voice and/or face input.

The remote conferencing security server module 355 may include a comparing component 416 for comparing an extraction of a detected voice and/or face input with a registered profiles of the participants to detect non-registered participants.

The remote conferencing security server module 355 may include an output component 418 for, when detecting a non-registered participant, providing an output action to at least some of the participants of the remote conference meeting to the non-registered participant.

The output component 418 may include a notifying component 419 for providing an output action in the form of a notification of a non-registered participant to some or all of the participants.

The output component 418 may include a modifying component 417 for, when detecting a non-registered participant at a remote location, modifying an input to and/or an output from the end user device at the remote location. The modifying component 417 may modifying the input to and/or the output from the remote location at which the non-registered participant is detected. The modifying component 417 may suspend the input and/or the output until the non-registered participant is allowed or removed.

FIG. 4B shows the remote conferencing security client module 350 that is provided at an end user device.

The remote conferencing security client module 350 includes a registration component 431 for registering participants at the end user device by extracting voice and/or face characteristics for a participant profile.

The remote conferencing security client module 350 includes a video input capturing component 421 and/or an audio input capturing component 422. In some embodiments, the video input capturing component 421 and/or the audio input capturing component 422 may be independent of the captured input to the conference meeting. The remote conferencing security client module 350 may include a cache for caching monitored content at the local computing device.

The remote conferencing security client module 350 includes a monitoring component 433 for monitoring an audio and/or a video input for participants at the end user device.

The remote conferencing security client module 350 may include a detecting component 434 for detecting a voice and/or face input in the monitored audio and/or video input and an extracting component 435 for extracting characteristics of the voice and/or face input.

The remote conferencing security client module 350 may include a comparing component 436 for comparing an extraction of a detected voice and/or face input with registered profiles of the participants to detect non-registered participants.

The remote conferencing security client module 350 may include an output component 438 for, when detecting a non-registered participant, providing an output action to at least some of the participants of the remote conference meeting. The output action may be provided locally at the end user device and/or may be provided to other remote end user devices participating in the remote conference meeting.

The output component 438 may include a notifying component 439 for providing an output action in the form of a notification of a non-registered participant to some or all of the participants.

The output component 438 may include a modifying component 437 for, when detecting a non-registered participant at a remote location, modifying an input to and/or an output to the conference meeting from the end user device. The modifying component 437 may suspend the input and/or the output until the non-registered participant is allowed or removed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

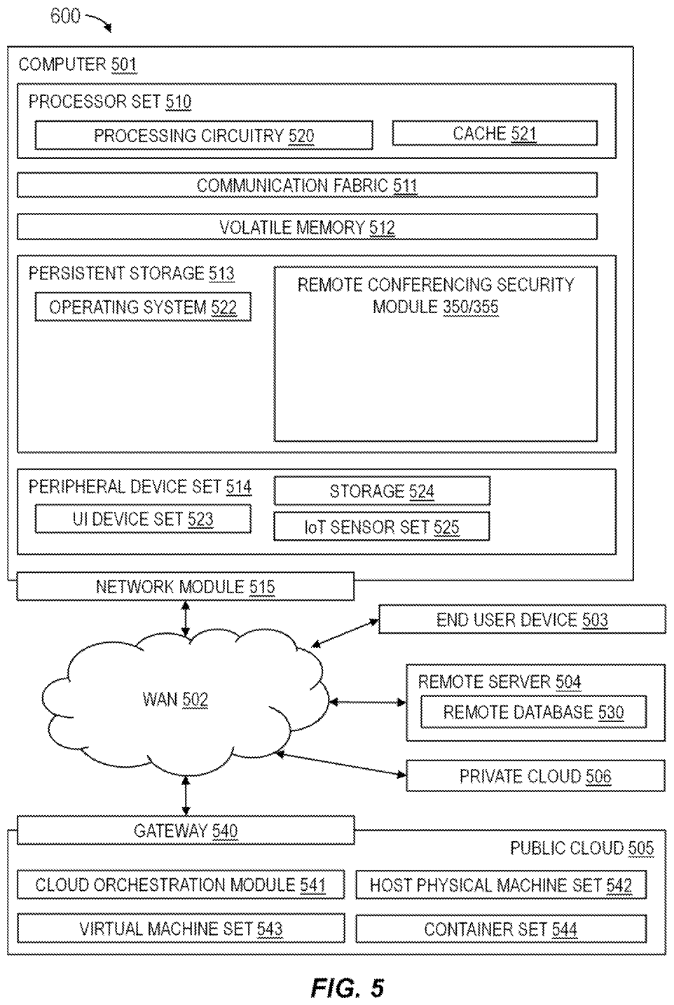

Referring to FIG. 5, computing environment 500 contains an example of an environment for the execution of at least some of the computer code involved in performing the inventive methods, such as a remote conference security module 350/355 at a client or server. In addition to module 350/355, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and module 350/355, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in module 350/355 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in module 350/355 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present disclosure.

What is claimed is:

1. A computer-implemented method for remote conference security control, the method comprising:
monitoring an audio and/or video input for participants at one or more remote locations of a remote conference meeting irrespective of sharing of the audio and/or video input at the time of monitoring;
comparing an extraction of a detected voice and/or face input with registered profiles of participants to detect non-registered participants; and
when detecting a non-registered participant, providing an output action to at least some of the participants of the remote conference meeting.

2. The method of claim 1, further comprising:
detecting a voice and/or face input in the monitored audio and/or video input and extracting characteristics of the voice and/or face input.

3. The method of claim 1, wherein the output action is a notification provided to at least some participants of the remote conference meeting.

4. The method of claim 1, wherein the output action is modifying an input to and/or an output from the remote location for the conference meeting at which the non-registered participant is detected.

5. The method of claim 4, wherein modifying the input to and/or the output from the remote location suspends the input and/or the output until the non-registered participant is allowed or removed.

6. The method of claim 1, further comprising:
monitoring video in varying directions during the conference meeting independently of a camera direction for input to the conference meeting.

7. The method of claim 1, wherein the method is carried out at a local computing device providing a remote location in the conference meeting, wherein the local computing device monitors only the remote location, wherein a local participant is registered with a user profile stored at the local computing device.

8. The method of claim 7, further comprising:
caching monitored content at the local computing device and comparing at the local computing device.

9. The method of claim 1, further comprising:
registering participants by extracting voice and/or face characteristics for a participant profile.

10. A system for remote conference security control, comprising:
a processor and a memory configured to provide computer program instructions to the processor to execute the function of the components;
a monitoring component for monitoring an audio and/or a video input for participants at one or more remote locations of a remote conference meeting configured to monitor irrespective of sharing of the audio and/or the video input at the time of monitoring;
a comparing component for comparing an extraction of a detected voice and/or face input with registered profiles of participants to detect non-registered participants; and
an output component for, when detecting a non-registered participant, providing an output action to at least some of the participants of the remote conference meeting.

11. The system of claim 10, further comprising:
a detecting component for detecting a voice and/or face input in the monitored audio and/or the video input and an extracting component for extracting characteristics of the voice and/or face input.

12. The system of claim 10, wherein the output component includes a notifying component that provides the output action to the at least some of the participants, wherein the output action comprises a notification.

13. The system of claim 10, wherein the output component includes a modifying component for, when detecting a non-registered participant at a remote location, modifying an input to and/or an output from the remote location at which the non-registered participant is detected.

14. The system of claim 13, wherein the modifying component for modifying the input to and/or the output from the remote location suspends the input and/or the output until the non-registered participant is allowed or removed.

15. The system of claim 10, wherein the monitoring component is independent of a video input to the conference meeting and is configured to monitor video in varying directions during the conference meeting.

16. The system of claim 10, wherein the system is provided at a local computing device provided at a remote location in the conference meeting.

17. The system of claim 16, further comprising a local registration component for registering a local participant with a user profile stored at the local computing device.

18. The system of claim 16, further comprising a cache for caching monitored content at the local computing device.

19. The system of claim 10, further comprising a registration component for registering participants by extracting voice and/or face characteristics for a participant profile.

20. A computer program product for remote conference security control, the computer program product comprising one or more computer readable storage media having program instructions collectively embodied therewith, the program instructions executable by one or more processors to cause the one or more processors to:
monitor an audio and/or video input for participants at one or more remote locations of a remote conference meeting irrespective of sharing of the audio and/or video input at the time of monitoring;
compare an extraction of a detected voice and/or face input with registered profiles of participants to detect non-registered participants; and
when detecting a non-registered participant, provide an output action to at least some of the participants of the remote conference meeting.
